(19) United States
(12) Patent Application Publication
(10) Pub. No.: US 2025/0358836 A1
(43) Pub. Date: Nov. 20, 2025

(54) CONFIGURED GRANTS FOR SIDELINK POSITIONING

(71) Applicant: Nokia Technologies Oy, Espoo (FI)

(72) Inventors: Taylan SAHIN, Munich (DE); Prajwal KESHAVAMURTHY, Munich (DE); Stepan KUCERA, Munich (DE); Ryan KEATING, Naperville, IL (US)

(21) Appl. No.: 19/288,840

(22) Filed: Aug. 1, 2025

Related U.S. Application Data
(63) Continuation of application No. PCT/EP2024/057404, filed on Mar. 20, 2024.
(60) Provisional application No. 63/465,862, filed on May 11, 2023.

(51) Int. Cl. H04W 72/40; H04W 92/18

(52) U.S. Cl. CPC H04W 72/40; H04W 92/18

(57) ABSTRACT

Systems, methods, apparatuses, and computer program products for resources to be managed by a scheduling entity. One method may include receiving, from a resource scheduling entity, at least one configured grant for sidelink transmission among a plurality of user equipments via high-layer signaling, and utilizing at least one resource within the at least one configured grant for sidelink transmission based on at least one indication by at least another user equipment activating or deactivating the at least one resource.

### CROSS-REFERENCE TO RELATED APPLICATION

This application is a bypass continuation of PCT Application PCT/EP2024/057404, filed Mar. 20, 2024, which claims the benefit of U.S. Provisional Application No. 63/465,862, filed May 11, 2023. The entire content of the above-referenced applications are hereby incorporated by reference.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for resource allocation for sidelink positioning.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, from a resource scheduling entity, at least one configured grant for sidelink transmission among a plurality of user equipments via high-layer signaling. The method may further include utilizing at least one resource within the at least one configured grant for sidelink transmission based on at least one indication by at least another user equipment activating or deactivating the at least one resource.

In accordance with certain example embodiments, an apparatus may include means for receiving, from a resource scheduling entity, at least one configured grant for sidelink transmission among a plurality of user equipments via high-layer signaling. The apparatus may further include means for utilizing at least one resource within the at least one configured grant for sidelink transmission based on at least one indication by at least another user equipment activating or deactivating the at least one resource.

In accordance with various example embodiments, a non-transitory computer readable medium may include program instructions that, when executed by an apparatus, cause the apparatus to perform at least a method. The method may include receiving, from a resource scheduling entity, at least one configured grant for sidelink transmission among a plurality of user equipments via high-layer signaling. The method may further include utilizing at least one resource within the at least one configured grant for sidelink transmission based on at least one indication by at least another user equipment activating or deactivating the at least one resource.

In accordance with some example embodiments, a computer program product may perform a method. The method may include receiving, from a resource scheduling entity, at least one configured grant for sidelink transmission among a plurality of user equipments via high-layer signaling. The method may further include utilizing at least one resource within the at least one configured grant for sidelink transmission based on at least one indication by at least another user equipment activating or deactivating the at least one resource.

In accordance with certain example embodiments, an apparatus may include at least one processor and at least one memory storing instructions that, when executed by the at least one processor, cause the apparatus at least to receive, from a resource scheduling entity, at least one configured grant for sidelink transmission among a plurality of user equipments via high-layer signaling. The at least one memory and instructions, when executed by the at least one processor, may further cause the apparatus at least to utilize at least one resource within the at least one configured grant for sidelink transmission based on at least one indication by at least another user equipment activating or deactivating the at least one resource.

In accordance with various example embodiments, an apparatus may include receiving circuitry configured to receive, from a resource scheduling entity, at least one configured grant for sidelink transmission among a plurality of user equipments via high-layer signaling. The apparatus may further include utilizing circuitry configured to utilize at least one resource within the at least one configured grant for sidelink transmission based on at least one indication by at least another user equipment activating or deactivating the at least one resource.

In accordance with some example embodiments, a method may include receiving, from a resource scheduling entity, at least one configured grant for sidelink transmission among a plurality of user equipments via high-layer signaling. The method may further include transmitting, to at least another user equipment, at least one indication configured to activate or deactivate at least one resource within the at least one configured grant for sidelink transmission.

In accordance with certain example embodiments, an apparatus may include means for receiving, from a resource scheduling entity, at least one configured grant for sidelink transmission among a plurality of user equipments via high-layer signaling. The apparatus may further include means for transmitting, to at least another user equipment, at least one indication configured to activate or deactivate at least one resource within the at least one configured grant for sidelink transmission.

In accordance with various example embodiments, a non-transitory computer readable medium may include program instructions that, when executed by an apparatus, cause the apparatus to perform at least a method. The method may include receiving, from a resource scheduling entity, at least one configured grant for sidelink transmission among a plurality of user equipments via high-layer signaling. The method may further include transmitting, to at least another user equipment, at least one indication configured to activate or deactivate at least one resource within the at least one configured grant for sidelink transmission.

In accordance with some example embodiments, a computer program product may perform a method. The method may include receiving, from a resource scheduling entity, at least one configured grant for sidelink transmission among a plurality of user equipments via high-layer signaling. The method may further include transmitting, to at least another user equipment, at least one indication configured to activate or deactivate at least one resource within the at least one configured grant for sidelink transmission.

In accordance with certain example embodiments, an apparatus may include at least one processor and at least one memory storing instructions that, when executed by the at least one processor, cause the apparatus at least to receive, from a resource scheduling entity, at least one configured grant for sidelink transmission among a plurality of user equipments via high-layer signaling. The at least one memory and instructions, when executed by the at least one processor, may further cause the apparatus at least to transmit, to at least another user equipment, at least one indication configured to activate or deactivate at least one resource within the at least one configured grant for sidelink transmission.

In accordance with various example embodiments, an apparatus may include receiving circuitry configured to receive, from a resource scheduling entity, at least one configured grant for sidelink transmission among a plurality of user equipments via high-layer signaling. The apparatus may further include transmitting circuitry configured to transmit, to at least another user equipment, at least one indication configured to activate or deactivate at least one resource within the at least one configured grant for sidelink transmission.

In accordance with some example embodiments, a method may include determining at least one configured grant among a plurality of user equipments for sidelink transmission. The method may further include transmitting the at least one configured grant to at least one of the plurality of user equipments via high-layer signaling.

In accordance with certain example embodiments, an apparatus may include means for determining at least one configured grant among a plurality of user equipments for sidelink transmission. The apparatus may further include means for transmitting the at least one configured grant to at least one of the plurality of user equipments via high-layer signaling.

In accordance with various example embodiments, a non-transitory computer readable medium may include program instructions that, when executed by an apparatus, cause the apparatus to perform at least a method. The method may include determining at least one configured grant among a plurality of user equipments for sidelink transmission. The method may further include transmitting the at least one configured grant to at least one of the plurality of user equipments via high-layer signaling.

In accordance with some example embodiments, a computer program product may perform a method. The method may include determining at least one configured grant among a plurality of user equipments for sidelink transmission. The method may further include transmitting the at least one configured grant to at least one of the plurality of user equipments via high-layer signaling.

In accordance with certain example embodiments, an apparatus may include at least one processor and at least one memory storing instructions that, when executed by the at least one processor, cause the apparatus at least to determine at least one configured grant among a plurality of user equipments for sidelink transmission. The at least one memory and instructions, when executed by the at least one processor, may further cause the apparatus at least to transmit the at least one configured grant to at least one of the plurality of user equipments via high-layer signaling.

In accordance with various example embodiments, an apparatus may include determining circuitry configured to determine at least one configured grant among a plurality of user equipments for sidelink transmission. The apparatus may further include transmitting circuitry configured to transmit the at least one configured grant to at least one of the plurality of user equipments via high-layer signaling.

In accordance with some example embodiments, a method may include transmitting to a scheduling entity a list of the plurality of user equipments suitable for sidelink configured grant. The method may further include transmitting to the scheduling entity a trigger to request resource allocation for the plurality of user equipments.

In accordance with certain example embodiments, an apparatus may include means for transmitting to a scheduling entity a list of the plurality of user equipments suitable for sidelink configured grant. The apparatus may further include means for transmitting to the scheduling entity a trigger to request resource allocation for the plurality of user equipments.

In accordance with various example embodiments, a non-transitory computer readable medium may include program instructions that, when executed by an apparatus, cause the apparatus to perform at least a method. The method may include transmitting to a scheduling entity a list of the plurality of user equipments suitable for sidelink configured grant. The method may further include transmitting to the scheduling entity a trigger to request resource allocation for the plurality of user equipments.

In accordance with some example embodiments, a computer program product may perform a method. The method may include transmitting to a scheduling entity a list of the plurality of user equipments suitable for sidelink configured grant. The method may further include transmitting to the scheduling entity a trigger to request resource allocation for the plurality of user equipments.

In accordance with certain example embodiments, an apparatus may include at least one processor and at least one memory storing instructions that, when executed by the at least one processor, cause the apparatus at least to transmit to a scheduling entity a list of the plurality of user equipments suitable for sidelink configured grant. The at least one memory and instructions, when executed by the at least one processor, may further cause the apparatus at least to transmit to the scheduling entity a trigger to request resource allocation for the plurality of user equipments.

In accordance with various example embodiments, an apparatus may include transmitting circuitry configured to transmit to a scheduling entity a list of the plurality of user equipments suitable for sidelink configured grant. The apparatus may further include transmitting circuitry configured to transmit to the scheduling entity a trigger to request resource allocation for the plurality of user equipments.

### BRIEF DESCRIPTION OF THE DRAWINGS

For a proper understanding of example embodiments, reference should be made to the accompanying drawings, wherein:

FIG. 1 illustrates an example of a sidelink positioning scenario;

FIG. 2 illustrates an example of a signaling diagram according to certain example embodiments;

FIG. 3 illustrates an example of another signaling diagram according to some example embodiments;

FIG. 4 illustrates an example of a flow diagram of a method according to various example embodiments;

FIG. 5 illustrates an example of a flow diagram of another method according to certain example embodiments;

FIG. 6 illustrates an example of a flow diagram of another method according to some example embodiments;

FIG. 7 illustrates an example of a flow diagram of another method according to various example embodiments;

FIG. 8 illustrates an example of various network devices according to certain example embodiments; and

FIG. 9 illustrates an example of a 5G network and system architecture according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for resource allocation for sidelink positioning is not intended to limit the scope of certain example embodiments, but is instead representative of selected example embodiments.

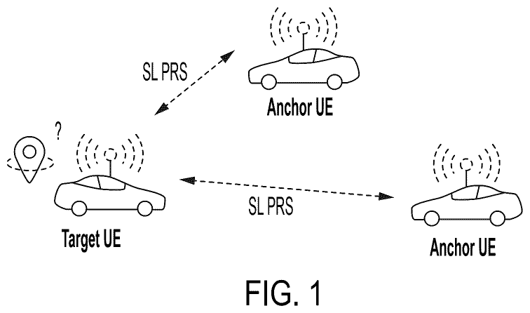

Sidelink (SL) positioning may be based on the transmissions of SL positioning reference signals (PRS) between an anchor and a target UE to enable localization of the target UE within precise latency and accuracy requirements of the corresponding SL positioning session. FIG. 1 illustrates a SL positioning scenario where a target UE is performing SL positioning session (i.e., exchanging SL-PRS with two anchor UEs in order to determine its location).

In SL positioning, different positioning methods may be utilized. For example, a SL time difference of arrival (TDOA) or SL (multi-) round trip time (RTT) method may enable localization of a target UE and/or ranging of a target UE with respect to a reference UE (e.g., anchor UE).

With respect to resource allocation for SL PRS transmissions, scheme 1 and scheme 2 are introduced, which may be based on NR SL mode 1 (i.e., network-controlled) and NR SL mode 2 (i.e., UE autonomous) resource allocation. In scheme 1, a network entity (NE) (e.g., eNB, gNB) may allocate resources for SL PRS in the form of dynamic grants or configured grants (CGs) of type 1 or type 2, as in legacy SL communication. In contrast, with scheme 2, the UE may autonomously select resources for SL PRS using sensing-based or random resource selection.

SL PRS transmissions may occur in SL resource pools that may be dedicated for SL positioning (i.e., dedicated pools) or shared with SL communications (i.e., shared pools).

With regards to scheme 1 SL-PRS resource allocation, a transmitting UE may receive SL-PRS resource allocation signaling from the network via higher layers from the location management function (LMF), dynamic grants, and/or through CG type 1/type 2 from the NE. Thus, the NEs may allocate resources for SL PRS transmissions in the form of dynamic grants or CGs of type 1 or type 2, as in legacy SL communication. In order to allow control of reliability, a dynamic SL grant downlink control information (DCI) may provide resources for one or multiple transmissions of a transport block. The transmissions may be subject to the SL hybrid automatic repeat request (HARQ) procedure (if that operation is enabled). A SL CG may be configured once, and may be used by the UE immediately, until it is released by radio resource control (RRC) signaling (i.e., Type 1). A UE may be permitted to continue using this type of SL CG when beam failure or physical layer problems occur in NR Uu until a radio link failure (RLF) detection timer expires, before falling back to an exception resource pool. The other type of SL CG (i.e., Type 2) may be configured once, but may not be used until the NE sends the UE a DCI indicating that it is now active, and only until another DCI indicates de-activation. The resources in both types may be a set of SL resources recurring with a periodicity which a NE may match to the characteristics of the vehicle-to-everything (V2X) traffic. Multiple CGs may be configured to allow provision for different services, traffic types, etc.

Scheduling activity by the NE may be driven by the UE reporting its SL traffic characteristics to the NE, and/or by performing a SL buffer status report (BSR) procedure similar to that on Uu to request a SL resource allocation from the NE. To provide assistance information for the configuration of CG, UE assistance information on traffic pattern may be reported to the network. The periodicity, time offset, message size, quality of service (QOS) info, and destination may be included in the reporting message. During handover, SL transmission and reception may be performed based on configuration of the exceptional transmission resource pool or SL CG Type 1 and reception resource pool of the target cell, as provided in the handover command.

SL positioning may include multiple UEs transmitting SL PRS in order to estimate the absolute position of the target UE. In some positioning methods, different UEs may need to transmit SL PRS with the shortest time possible between the transmissions, or even at the same time. For example, in SL RTT method, both the target UE and anchor UE (or multiple anchor UEs) may transmit SL PRS to each other; if the time between the transmissions is too long, UEs may move or experience clock drift/change of synchronization reference/status, which may impact the positioning accuracy, as well as the positioning latency. Similarly, in certain SL TDOA methods, multiple anchor UEs may transmit SL PRS at the same time (or as close as possible), while the target UE measures the difference in received time between the signals to calculate its location information.

Certain example embodiments described herein may have various benefits and/or advantages to overcome the disadvantages described above. For example, in certain example embodiments, SL resources for multiple UEs may be allocated in a timely, reliable, and efficient manner in order to achieve the required QoS of SL positioning involving multiple UEs that transmit SL PRS. Thus, certain example embodiments discussed below are directed to improvements in computer-related technology.

In certain example embodiments, a group of SL positioning UEs (e.g., all anchors belonging to the same positioning session in response to a given localization request) may be identified (e.g., via LMF or server UE). SL PRS transmissions of the UE group may be collectively scheduled by higher layers (e.g., by NE via RRC in Scheme 1 resource allocation or by server UE, possibly via SL positioning protocol (SLPP), or RRC/medium access control (MAC)-control element (CE) in Scheme 2 resource allocation) in a single step by using a CG whereby all (or just concurrent) transmissions are configured with orthogonal SL PRS sequences. These grants may be collectively or individually (de) activated using low-layer signaling over SL (e.g., SL control information (SCI) without any network involvement (e.g., in out-of-coverage conditions where legacy DCI activation is impossible)), preferably a target UE's SCI to permit UE multiplexing (within said UE group) with up to RE-level and symbol-level resource granularity, and general transmission adaptation to changing link conditions among UEs.

Some example embodiments may improve handling of SL transmissions from multiple UEs in SL positioning, where SL PRS transmissions need to be close in time as much as possible, and may be activated/deactivated based on changing link conditions between the anchor(s) and target(s) of SL positioning. Various example embodiments may apply to any type of SL transmissions (communication, discovery, positioning, etc.) and any number of scheduled UEs (one or more).

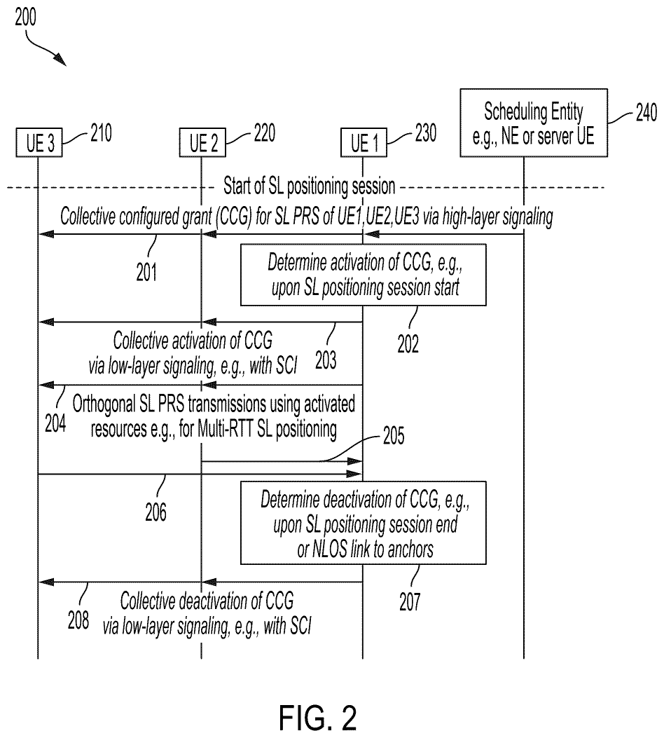

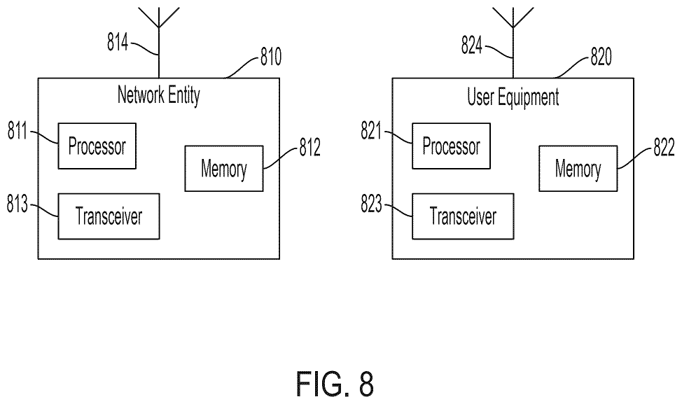

FIG. 2 illustrates an example of a signaling diagram depicting for the resources to be managed by a scheduling entity such as a NE or a UE (e.g., server or target UE). UE 210, UE 220, and UE 230 may be similar to UE 820, and scheduling entity 240 may be similar to NE 810 or UE 820, as illustrated in FIG. 8, according to certain example embodiments.

Initially, UE 210, UE 220, UE 230, and scheduling entity 240 may start a SL positioning session. Scheduling entity 240 may be informed about potential UEs (e.g., UE 210, UE 220, and UE 230), whose SL PRS transmissions may be grouped together for a CCG resource allocation. Such information may come from one of the UEs involved in SL positioning such as the target UE or server UE (e.g., UE 210, UE 220, and UE 230), or it may also come from a core network entity, such as a LMF managing the SL positioning.

In addition, scheduling entity 240 may be requested/triggered to perform resource allocation for SL PRS transmissions pertaining to the informed group of UEs. Such signaling may indicate required SL PRS transmission characteristics (e.g., SL PRS parameters such as bandwidth and periodicity), and/or SL positioning QoS requirements (e.g., positioning accuracy and latency) received from a UE or LMF. In turn, scheduling entity 240 may determine the at least one SL collective CG (CCG) for SL PRS transmissions of one or more of UE 210, UE 220, and UE 230. The at least one SL CCGs may consist of SL resources allocated for the UEs, including their multiplexing, which may include certain time/frequency/code-domain resources including SL PRS sequence IDs used to generate reference signal sequences. Time/frequency resources may have a granularity of resource elements (RE) and symbol, as well as coarser granularity in terms of frequency subchannels and time slots/mini-slots, etc.

At operation 201, scheduling entity 240 may transmit at least one CCG to UE 210, UE 220, and/or UE 230 via high-layer signaling. In certain example embodiments, where scheduling entity 240 is a NE, scheduling entity 240 may provide the CCG via DL broadcast/groupcast/unicast signaling (e.g., via RRC (re-) configuration message). Alternatively, where scheduling entity 240 is a UE, scheduling entity 240 may provide at least one CCG via SL broadcast/groupcast/unicast signaling (e.g., via SLPP message or MAC-CE, or SL unicast via SL RRC). In certain example embodiments, UE 210, UE 220, and/or UE 230 may relay the at least one CCG to one or more other UEs.

In some example embodiments, the at least one CCG may indicate at least one of the following: how to activate/deactivate resources (e.g., UEs (e.g., identified by ID) that may perform activation/deactivation); any threshold values or ranges associated with (de) activation (e.g., in time or distance); SL channel conditions (e.g., line of sight (LOS)/non-line of sight (NLOS), SL reference signal received power (RSRP), etc.); SL congestion (e.g., measured by SL channel busy ratio (CBR) and/or channel occupancy ratio (CR)); and coverage conditions (e.g., defined by Uu and/or SL RRC state).

In various example embodiments, the at least one CCG may optionally be configured with some restrictions or conditions on the use of the at least one CCG. For example, the at least one CCG may only be used in coverage of assigning NEs, or only in coverage of the assigning NEs plus out of coverage. In addition, at least one of the UEs may need to be in coverage of the assigning NE for the group of UEs to use the at least one CCG (e.g., server/target UE). A timer may also be associated with the at least one CCG such that if a UE hasn't been in coverage of the assigning NE within the timer length then the at least one CCG is no longer valid. In addition, the at least one CCG may be associated with a geographical area, and may be activated only when the UEs are in the indicated area (UEs may know its coarse location and may identify the geographical area). This may be used in scenarios where the network is aware of the coverage gap, and may provide the at least one CCG for those specific areas.

At operation 202, UE 230 may determine activation of the at least one CCG (e.g., upon SL positioning session start).

At operation 203, UE 230 may transmit to UE 210 and/or UE 220 a collective activation of the at least one CCG via low-layer signaling (e.g., with SCI).

At operation 204, UE 230 may transmit orthogonal SL PRS transmissions to UE 210 and/or UE 220 using indicated/activated resources (e.g., for multi-RTT SL positioning); at operation 205, UE 220 may transmit orthogonal SL PRS transmissions to UE 230 using indicated/activated resources (e.g., for multi-RTT SL positioning); and similarly, at operation 206, UE 210 may transmit orthogonal SL PRS transmissions to UE 230 using indicated/activated resources (e.g., for multi-RTT SL positioning). In certain example embodiments, the (configured) UE (e.g., target UE) that may activate the SL CCGs may indicate the activation to other UEs using a control indication via SL (e.g., via SCI) which may be accompanied by its own SL PRS or physical SL shared channel (PSSCH) transmission. In some example embodiments, scheduling entity 240 may still use DCI to activate the at least one CCG with the target UE. The target UE (i.e., UE 230) may then transmit SCI configured to activate the at least one CCG for any UEs which are no longer in coverage of scheduling entity 240. This may provide additional control to scheduling entity 240 over the resources.

In certain example embodiments (e.g., if configured), UE 230 may also indicate the activation of resources to scheduling entity 240 (e.g., via UL control information to scheduling entity 240, or implicitly via SCI to the scheduling UE).

At operation 207, UE 230 may determine deactivation of CCG (e.g., upon SL positioning session end or NLOS link to anchors). In various example embodiments, the configured UE (i.e., UE 230) may be one of the SL PRS transmitting UEs (e.g., anchor UE in SL TDOA session), which may activate the at least one CCG at one or more UEs (e.g., other anchor UEs) which may transmit SCI for its own SL PRS transmission. The activation of the anchor UE's resources may be performed by scheduling entity 240 or the anchor UE (i.e., UE 230) itself.

In various example embodiments, the (configured) UE 230 (e.g., target UE or server UE) may later deactivate the at least one SL CCG, such as when SL positioning is completed or upon experiencing undesirable link conditions among the UEs (e.g., due to NLOS between target and anchor UEs).

At operation 208, UE 230 may transmit collective deactivation of the at least one CCG via low-layer signaling (e.g., with SCI). The deactivation indication to UE 210 and UE 220, as well as to scheduling entity 240, may follow signaling similar to activation.

In some example embodiments, activation and/or deactivation may relate to only a subset of the resources or UEs in the CG.

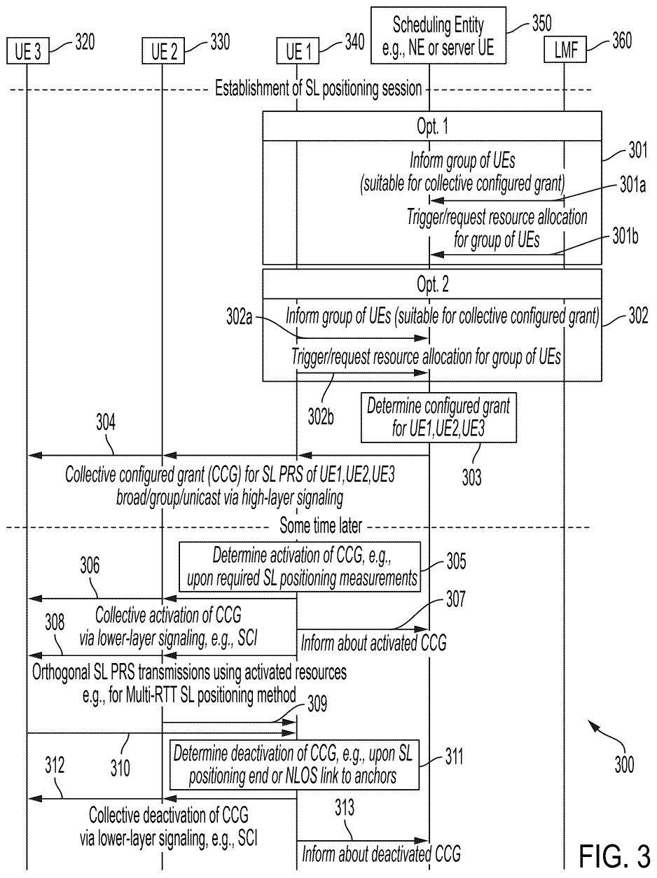

FIG. 3 illustrates an example of a signaling diagram for resources to be managed by a scheduling entity such as a NE or a UE (e.g., server or target UE), which may be similar to the operations shown in FIG. 2. UE 320, UE 330, and UE 340 may be similar to UE 820, and scheduling entity 350 and LMF 360 may be similar to NE 810 or UE 820, as illustrated in FIG. 8, according to certain example embodiments.

In certain example embodiments of a first option 301, at operation 301a, LMF 360 may transmit to scheduling entity 350 an indication of a group of UEs (e.g., UE 320, UE 330, and UE 340), which may be suitable for CCGs. At operation 301b, LMF 360 may transmit to scheduling entity 350 a trigger/request resource allocation for the group of UEs.

In some example embodiments of a second option 302, at operation 302a, UE 340 may transmit to scheduling entity 350 an indication of a group of UEs (e.g., UE 330, UE 330, and UE 340), which may also be suitable for CCGs. At operation 302b, UE 340 may transmit to scheduling entity 350 a trigger/request resource allocation for the group of UEs.

At operation 303, scheduling entity 350 may determine at least one CCG for UE 320, UE 330, and/or UE 340.

At operation 304, scheduling entity 360 may transmit to UE 320, UE 330, and UE 340 a CCG for SL PRS of UE 320, UE 330, and UE 340, which may be broad/group/unicast via high-layer signaling.

At operation 305, UE 340 may determine an activation of the CCG (e.g., upon required SL positioning measurements).

At operation 306, UE 340 may transmit to UE 320 and UE 330 a collective activation of CCG via low-layer signaling (e.g., SCI).

At operation 307, UE 340 may transmit to scheduling entity 360 an indication of the activated CCG.

At operation 308, UE 340 may transmit orthogonal SL PRS transmissions to UE 320 and/or UE 330 using indicated/activated resources (e.g., for multi-RTT SL positioning); at operation 309, UE 330 may transmit orthogonal SL PRS transmissions to UE 340 using indicated/activated resources (e.g., for multi-RTT SL positioning); and similarly, at operation 310, UE 320 may transmit orthogonal SL PRS transmissions to UE 340 using indicated/activated resources (e.g., for multi-RTT SL positioning).

At operation 311, UE 340 may determine deactivation of CCG (e.g., upon SL positioning end or NLOS link to anchors).

At operation 312, UE 340 may transmit to UE 320 and/or UE 330 a collective deactivation of CCG via low-layer signaling (e.g., SCI).

At operation 313, UE 340 may transmit to scheduling entity 360 an indication of the deactivated CCG.

In various example embodiments, instead of using SL control information transmitted directly between the UEs, activation/deactivation of at least one CCG may be indicated via signaling over the network (e.g., target UE first indicates it to NE via UL, and then the NE forwards this indication to other UEs via DL). Such operation may be desirable when UEs may not communicate with each other due to blocked links, and wants to cease SL PRS transmissions that are unnecessarily wasting resources. The communication between LMF and NE may occur via New Radio Positioning Protocol A signaling.

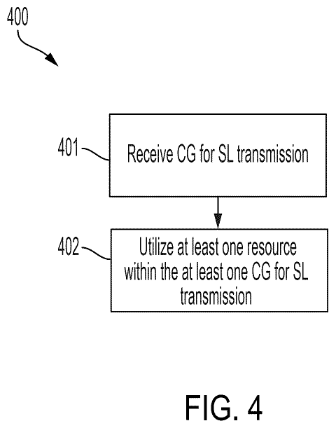

FIG. 4 illustrates an example of a flow diagram of a method 400 that may be performed by a UE, such as UE 820 as illustrated in FIG. 8, according to various example embodiments.

At step 401, the method may include receiving from a resource scheduling entity, such as NE 810 and/or UE 820 as illustrated in FIG. 8, at least one CG for SL transmission among a plurality of UE via high-layer signaling. The at least one CG may be configured for the plurality of UE in a SL positioning session. The at least one CL may include at least one resource related to a plurality of orthogonal SL PRS sequences. The plurality of orthogonal SL PRS sequences may be orthogonal in at least one of time domain, frequency domain, or code domain.

At step 402, the method may further include utilizing at least one resource within the at least one CG for SL transmission based on at least one indication by at least another UE activating or deactivating the at least one resource. The at least one indication may indicate an activation and/or a deactivation of the at least one resource for the plurality of UE in the SL positioning session via low-layer signaling. The low-layer signaling may include SCI. The high-layer signaling may include at least one of RRC signaling, MAC CE signaling, LPP signaling, or SLPP signaling.

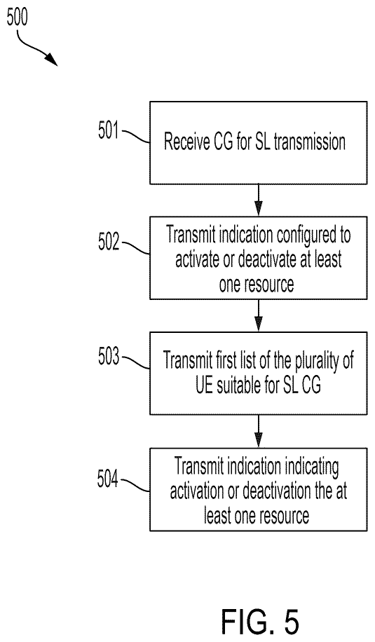

FIG. 5 illustrates an example of a flow diagram of a method 500 that may be performed by a UE, such as UE 820 as illustrated in FIG. 8, according to various example embodiments.

At step 501, the method may include receiving, from a resource scheduling entity, such as NE 810 and/or UE 820 as illustrated in FIG. 8, at least one CG for SL transmission among a plurality of UE via high-layer signaling.

At step 502, the method may further include transmitting, to at least another UE, at least one indication configured to activate or deactivate at least one resource within the at least one CG for SL transmission.

The at least one CG may be configured for the plurality of UE in a SL positioning session. The at least one CG comprises at least one resource related to a plurality of orthogonal SL PRS sequences. The plurality of orthogonal SL PRS sequences may be orthogonal in at least one of time domain, frequency domain, or code domain. The at least one indication may indicate an activation and/or a deactivation of the at least one resource for the plurality of UE in the SL positioning session via low-layer signaling. The low-layer signaling may include SCI. The high-layer signaling may include at least one of RRC signaling, MAC CE signaling, LPP signaling, or SLPP signaling.

At step 503, the method may further include transmitting, to the resource scheduling entity, a first list of the plurality of UE suitable for SL CG, and transmitting to the resource scheduling entity a first trigger to request resource allocation for the plurality of UE.

At step 504, the method may further include transmitting, to the resource scheduling entity, the at least one indication indicating activation or deactivation the at least one resource within the at least one CG for SL transmission.

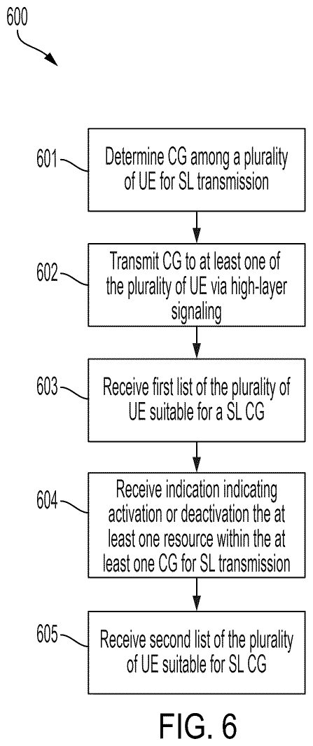

FIG. 6 illustrates an example of a flow diagram of a method 600 that may be performed by a NE or UE, such as NE 810 and/or UE 820 as illustrated in FIG. 8, according to various example embodiments.

At step 601, the method may include determining at least one CG among a plurality of UE for SL transmission.

At step 602, the method may further include transmitting the at least one CG to at least one of the plurality of UE via high-layer signaling.

The at least one CG is determined for the plurality of UE in a SL positioning session. The at least one CG may include at least one resource related to a plurality of orthogonal SL PRS sequences. The plurality of orthogonal SL PRS sequences may be orthogonal in at least one of time domain, frequency domain, or code domain.

At step 603, the method may further include receiving from a UE a first list of the plurality of UE suitable for a SL CG, and receiving from the UE a first trigger to request resource allocation for the plurality of UE.

At step 604, the method may further include receiving from the UE at least one indication indicating activation or deactivation the at least one resource within the at least one CG for SL transmission.

At step 605, the method may further include receiving from a core NE a second list of the plurality of UE suitable for SL CG, and receiving from the core NE a second trigger to request resource allocation for the plurality of UE.

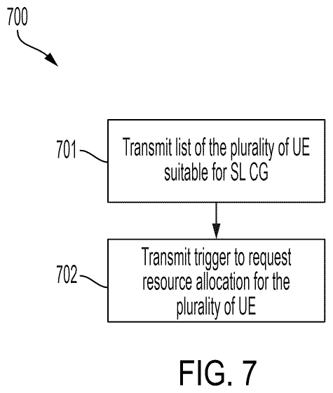

FIG. 7 illustrates an example of a flow diagram of a method 700 that may be performed by a LMF, such as NE 810 and/or UE 820 as illustrated in FIG. 8, according to various example embodiments. At step 701, the method may include transmitting to a scheduling entity a list of the plurality of UE suitable for SL CG. At step 702, the method may further include transmitting to the scheduling entity a trigger to request resource allocation for the plurality of UE. The apparatus may include a LMF.

FIG. 8 illustrates an example of a system according to certain example embodiments. In one example embodiment, a system may include multiple devices, such as, for example, NE 810 and/or UE 820.

NE 810 may be one or more of a base station (e.g., 3G UMTS NodeB, 4G LTE Evolved NodeB, or 5G NR Next Generation NodeB), a serving gateway, a server, and/or any other access node or combination thereof.

NE 810 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 820 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 810 and/or UE 820 may be one or more of a citizens broadband radio service device (CBSD).

NE 810 and/or UE 820 may include at least one processor, respectively indicated as 811 and 821. Processors 811 and 821 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 812 and 822. The memory may be fixed or removable. The memory may include computer program instructions or computer code contained therein. Memories 812 and 822 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 811 and 821, memories 812 and 822, and any subset thereof, may be configured to provide means corresponding to the various blocks of FIGS. 2-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 8, transceivers 813 and 823 may be provided, and one or more devices may also include at least one antenna, respectively illustrated as 814 and 824. The device may have many antennas, such as an array of antennas configured for multiple input multiple output (MIMO) communications, or multiple antennas for multiple RATs. Other configurations of these devices, for example, may be provided. Transceivers 813 and 823 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 2-7). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 2-7. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

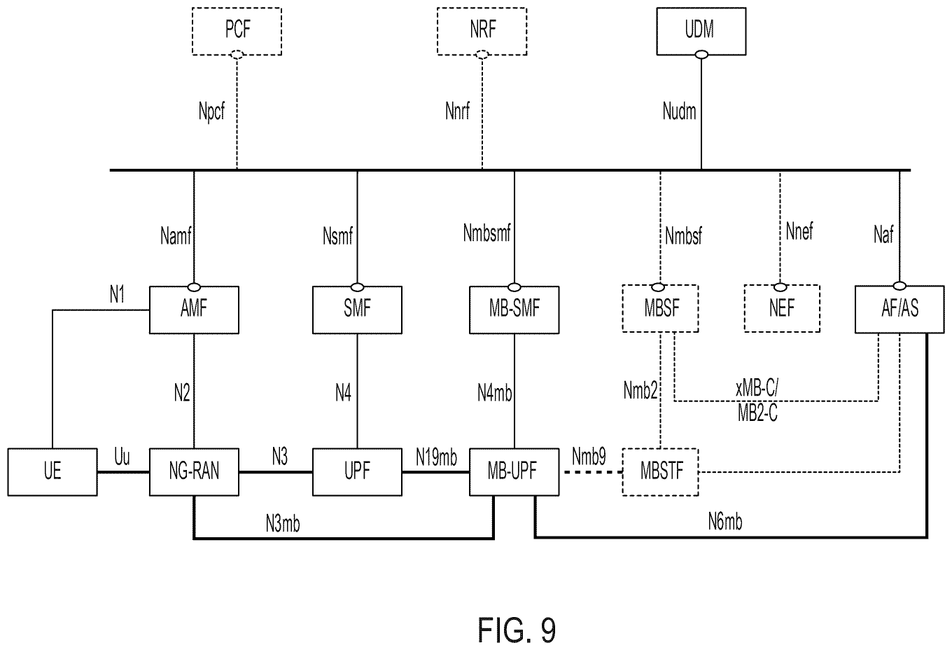

FIG. 9 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 9 may be similar to NE 810 and UE 820, respectively. The user plane function (UPF) may provide services such as intra-RAT and inter-RAT mobility, routing and forwarding of data packets, inspection of packets, user plane QoS processing, buffering of downlink packets, and/or triggering of downlink data notifications. The application function (AF) may primarily interface with the core network to facilitate application usage of traffic routing and interact with the policy framework.

According to certain example embodiments, processors 811 and 821, and memories 812 and 822, may be included in or may form a part of processing circuitry or control circuitry. In addition, in some example embodiments, transceivers 813 and 823 may be included in or may form a part of transceiving circuitry.

In some example embodiments, an apparatus (e.g., NE 810 and/or UE 820) may include means for performing a method, a process, or any of the variants discussed herein. Examples of the means may include one or more processors, memory, controllers, transmitters, receivers, and/or computer program code for causing the performance of the operations.

In various example embodiments, apparatus 820 may be controlled by memory 822 and processor 821 to receive, from a resource scheduling entity, at least one configured grant for sidelink transmission among a plurality of user equipments via high-layer signaling, and utilize at least one resource within the at least one configured grant for sidelink transmission based on at least one indication by at least another user equipment activating or deactivating the at least one resource.

Certain example embodiments may be directed to an apparatus that includes means for performing any of the methods described herein including, for example, means for receiving, from a resource scheduling entity, at least one configured grant for sidelink transmission among a plurality of user equipments via high-layer signaling, and means for utilizing at least one resource within the at least one configured grant for sidelink transmission based on at least one indication by at least another user equipment activating or deactivating the at least one resource.

In various example embodiments, apparatus 820 may be controlled by memory 822 and processor 821 to receive, from a resource scheduling entity, at least one configured grant for sidelink transmission among a plurality of user equipments via high-layer signaling, and transmit, to at least another user equipment, at least one indication configured to activate or deactivate at least one resource within the at least one configured grant for sidelink transmission.

Certain example embodiments may be directed to an apparatus that includes means for performing any of the methods described herein including, for example, means for receiving, from a resource scheduling entity, at least one configured grant for sidelink transmission among a plurality of user equipments via high-layer signaling, and means for transmitting, to at least another user equipment, at least one indication configured to activate or deactivate at least one resource within the at least one configured grant for sidelink transmission.

In various example embodiments, apparatus 810 and/or apparatus 820 may be controlled by memory 812/822 and processor 811/821 to determine at least one configured grant among a plurality of user equipments for sidelink transmission, and transmit the at least one configured grant to at least one of the plurality of user equipments via high-layer signaling.

Certain example embodiments may be directed to an apparatus that includes means for performing any of the methods described herein including, for example, means for determining at least one configured grant among a plurality of user equipments for sidelink transmission, and means for transmitting the at least one configured grant to at least one of the plurality of user equipments via high-layer signaling.

In various example embodiments, apparatus 820 may be controlled by memory 822 and processor 821 to transmit to a scheduling entity a list of the plurality of user equipments suitable for sidelink configured grant, and transmit to the scheduling entity a trigger to request resource allocation for the plurality of user equipments.

Certain example embodiments may be directed to an apparatus that includes means for performing any of the methods described herein including, for example, means for transmitting to a scheduling entity a list of the plurality of user equipments suitable for sidelink configured grant, and means for transmitting to the scheduling entity a trigger to request resource allocation for the plurality of user equipments.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP 3^{rd} Generation Partnership Project
5G 5^{th} Generation
5GC 5^{th} Generation Core
6G 6^{th} Generation
AF Application Function
AoA Angle of Arrival
ASIC Application Specific Integrated Circuit
BSR Buffer Status Report
CBR Channel Busy Ratio
CBSD Citizens Broadband Radio Service Device
CCG Collective Configured Grant
CE Control Elements
CG Configured Grant
CPU Central Processing Unit
CR Channel Occupancy Ratio
CU Centralized Unit
DCI Downlink Control Information
DL Downlink
DU Distributed Unit
eMBB Enhanced Mobile Broadband
eNB Evolved Node B
gNB Next Generation Node B
GPS Global Positioning System
HARQ Hybrid Automatic Repeat Request
HDD Hard Disk Drive
IoT Internet of Things
LMF Location Management Function
LOS Line of Sight
LPP Long-Term Evolution Positioning Protocol
LTE Long-Term Evolution
LTE-A Long-Term Evolution Advanced
MAC Medium Access Control
MIMO Multiple Input Multiple Output
NE Network Entity
NG Next Generation
NR New Radio
PDA Personal Digital Assistance
PRS Positioning Reference Signal
PSSCH Physical Sidelink Shared Channel
QoS Quality of Service
RAN Radio Access Network
RAT Radio Access Technology
RE Resource Element
RF Radio Frequency
RRC Radio Resource Control
SCI Sidelink Control Information
SL Sidelink
UE User Equipment

We claim:

1. An apparatus comprising:
at least one processor; and
at least one memory storing instructions that, when executed by the at least one processor, cause the apparatus at least to:
receive, from a resource scheduling entity, at least one configured grant for sidelink transmission among a plurality of user equipments via high-layer signaling; and
utilize at least one resource within the at least one configured grant for sidelink transmission based on at least one indication by at least another user equipment activating or deactivating the at least one resource.

2. The apparatus of claim 1, wherein the at least one configured grant is configured for the plurality of user equipments in a sidelink positioning session.

3. The apparatus of claim 1, wherein the at least one configured grant comprises at least one resource related to a plurality of orthogonal sidelink positioning reference signal sequences.

4. The apparatus of claim 3, wherein the plurality of orthogonal sidelink positioning reference signal sequences are orthogonal in at least one of the following: time domain, frequency domain, or code domain.

5. The apparatus of claim 1, wherein the at least one indication indicates an activation or a deactivation of the at least one resource for the plurality of user equipments in the sidelink positioning session via low-layer signaling.

6. The apparatus of claim 5, wherein the low-layer signaling comprises sidelink control information.

7. The apparatus of claim 1, wherein the high-layer signaling comprises at least one of the following: radio resource control signaling, medium access control control element signaling, long-term evolution positioning protocol signaling, or sidelink positioning protocol signaling.

8. An apparatus comprising:
at least one processor; and
at least one memory storing instructions that, when executed by the at least one processor, cause the apparatus at least to:
receive, from a resource scheduling entity, at least one configured grant for sidelink transmission among a plurality of user equipments via high-layer signaling; and
transmit, to at least another user equipment, at least one indication configured to activate or deactivate at least one resource within the at least one configured grant for sidelink transmission.

9. The apparatus of claim 8, wherein the at least one configured grant is configured for the plurality of user equipments in a sidelink positioning session.

10. The apparatus of claim 9, wherein the at least one configured grant comprises at least one resource related to a plurality of orthogonal sidelink positioning reference signal sequences.

11. The apparatus of claim 10, wherein the plurality of orthogonal sidelink positioning reference signal sequences are orthogonal in at least one of the following: time domain, frequency domain, or code domain.

12. The apparatus of claim 8, wherein the at least one indication indicates an activation or a deactivation of the at least one resource for the plurality of user equipments in the sidelink positioning session via low-layer signaling.

13. The apparatus of claim 12, wherein the low-layer signaling comprises sidelink control information.

14. The apparatus of claim 8, wherein the high-layer signaling comprises at least one of the following: radio resource control signaling, medium access control control element signaling, long-term evolution positioning protocol signaling, or sidelink positioning protocol signaling.

15. The apparatus of claim 8, wherein the instructions, when executed by the at least one processor, further cause the apparatus at least to:
transmit, to the resource scheduling entity, a first list of the plurality of user equipments suitable for sidelink configured grant; and
transmit to the resource scheduling entity a first trigger to request resource allocation for the plurality of user equipments.

16. The apparatus of claim 8, wherein the instructions, when executed by the at least one processor, further cause the apparatus at least to:
transmit, to the resource scheduling entity, the at least one indication indicating activation or deactivation the at least one resource within the at least one configured grant for sidelink transmission.

17. An apparatus comprising:
at least one processor; and
at least one memory storing instructions that, when executed by the at least one processor, cause the apparatus at least to:
determine at least one configured grant among a plurality of user equipments for sidelink transmission; and
transmit the at least one configured grant to at least one of the plurality of user equipments via high-layer signaling.

18. The apparatus of claim 17, wherein the at least one configured grant is determined for the plurality of user equipments in a sidelink positioning session.

19. The apparatus of claim 17, wherein the instructions, when executed by the at least one processor, further cause the apparatus at least to:
receive from a user equipment a first list of the plurality of user equipments suitable for a sidelink configured grant; and
receive from the user equipment a first trigger to request resource allocation for the plurality of user equipments.

20. The apparatus of claim 17, wherein the instructions, when executed by the at least one processor, further cause the apparatus at least to:
receive from the user equipment at least one indication indicating activation or deactivation the at least one resource within the at least one configured grant for sidelink transmission.
